(19) United States
(12) Patent Application Publication
(10) Pub. No.: US 2026/0078009 A1
(43) Pub. Date: Mar. 19, 2026

(54) METHODS OF PREPARING ZEOLITES WITH A FIXED BED REACTOR

(71) Applicant: Saudi Arabian Oil Company, Dhahran (SA)

(72) Inventors: Lianhui Ding, Dhahran (SA); Faisal Alotaibi, Al-Khobar (SA); Emad N. Al-Shafei, Dhahran (SA); Mohammad F. Aljishi, Dhahran (SA)

(21) Appl. No.: 18/886,460

(22) Filed: Sep. 16, 2024

(51) Int. Cl. C01B 39/40

(52) U.S. Cl. CPC C01B 39/40

(57) ABSTRACT

This disclosure relates to methods of preparing a zeolite including heating the dry gel zeolite in a fixed bed reactor to form a zeolite.

### TECHNICAL FIELD

This document relates to methods of preparing a zeolite including heating the dry gel zeolite in a fixed bed reactor to form a zeolite.

### BACKGROUND

Zeolites, such as zeolite beta and Zeolite Socony Mobil-5 (ZSM-5), are widely used in petroleum processing for various applications, such as catalytic cracking, catalytic reforming, and hydrocracking. For many such applications, poor diffusion efficiency of bulky molecules through zeolite pores limits their utility. Thus, smaller zeolite particle sizes are preferred, as smaller particle size correlates to higher external surface area and shorter diffusion paths of molecules through the zeolite pores.

Thus, the development of methods that result in smaller, more uniform zeolite particles are needed.

### SUMMARY

Provided in the present disclosure are methods of preparing a zeolite, the method including: combining zeolite precursor materials; stirring the zeolite precursor materials to form a zeolite hydrogel; heating the zeolite hydrogel to form a zeolite dry gel; loading the zeolite dry gel into a fixed bed reactor; heating the fixed bed reactor to a temperature from about 100° C. to about 200° C.; and while maintaining the fixed bed reactor at the temperature, flowing a steam into the fixed bed reactor to pass through the zeolite dry gel, forming a zeolite from the zeolite dry gel.

In some embodiments, the method further includes, while heating the zeolite hydrogel, stirring the zeolite hydrogel.

In some embodiments, the method further includes drying the hydrogel in an oven.

In some embodiments, the method further includes, prior to loading the zeolite dry gel into the fixed bed reactor, grounding the zeolite dry gel into a powder form.

In some embodiments, the loading of the zeolite dry gel into the fixed bed reactor further includes inserting a support in the fixed bed reactor; and placing the zeolite dry gel over the support.

In some embodiments, the method further includes, while flowing the steam into the fixed bed reactor, holding a pressure from about 1 bar to about 20 bar in the fixed bed reactor.

In some embodiments, the pressure is from about 5 bar to about 10 bar.

In some embodiments, the method further includes flowing a carrier gas into the fixed bed reactor to pressurize the fixed bed reactor.

In some embodiments, flowing the steam into the fixed bed reactor includes using a pump connected to a tank including water, flowing the water to the fixed bed reactor at a flow rate from about 100 mL/h to about 300 mL/h; and generating the steam from the water flowed at the flow rate.

In some embodiments, the fixed bed reactor is heated to a temperature from about 140° C. to about 160° C.

Also provided in the present disclosure are methods of preparing a zeolite, the method including:
loading a zeolite dry gel into a fixed bed reactor including:
   a tubular reactor body,
   a support within the tubular reactor body to support the zeolite dry gel, and
   a furnace to heat the tubular reactor body;
using the furnace, heating the fixed bed reactor to a temperature from about 100° C. to about 200° C.; and
while maintaining the fixed bed reactor at the temperature, flowing a steam into the fixed bed reactor to pass through the zeolite dry gel, forming a zeolite from the zeolite dry gel.

In some embodiments, the fixed bed reactor is a part of a reactor system including a tank including water; and a pump configured to flow the water from the tank to the fixed bed reactor at a flow rate from about 100 mL/h to about 300 mL/h, where the steam is generated from the water.

In some embodiments, the reactor system further includes a pressure gauge to monitor a pressure inside the fixed bed reactor; a pressure relief valve disposed between the pump and the fixed bed reactor; and a no return valve disposed between the pressure relief valve and the fixed bed reactor.

In some embodiments, the reactor system further includes an accumulator disposed downstream to the fixed bed reactor.

In some embodiments, the reactor system further includes a heating section disposed upstream to the tubular reactor body and configured to generate the steam from the water before entering the tubular reactor body.

In some embodiments, the fixed bed reactor is positioned vertically, and the steam passes through the zeolite dry gel from a top side to a bottom side.

Also provided in the present disclosure are methods of preparing a zeolite, the method including:
forming a zeolite hydrogel by mixing zeolite precursors in water, the zeolite precursors including an aluminum source, a silica source, and a template source;
heating the zeolite hydrogel under stirring;
drying the zeolite hydrogel in an oven, forming a zeolite dry gel;
grounding the zeolite dry gel into a power form;
after grounding, loading the zeolite dry gel into a fixed bed reactor;
heating the fixed bed reactor to a temperature from about 100° C. to about 200° C.; and
while maintaining the fixed bed reactor at the temperature, flowing a steam into the fixed bed reactor to pass through the zeolite dry gel, forming a zeolite from the zeolite dry gel;
washing the zeolite with water; and
calcinating the zeolite at a temperature from about 550° C. to about 750° C.

In some embodiments, the aluminum source includes NaAlO₂, aluminum isopropoxide (AIP), Al₂(SO₄)₃, Al(NO₃)₃, AlCl₃, metal Al, aluminum powder, Al(OH)₃, or Al₂O₃.

In some embodiments, the silicon source includes tetraethylorthosilicate (TEOS), colloidal silica, Na₂SiO₃, or fumed silica.

In some embodiments, the template source includes tetrapropylammonium hydroxide (TPAOH) or tetraethylammonium hydroxide (TEAOH).

### DESCRIPTION OF DRAWINGS

FIG. 1 is an exemplary schematic of a fixed bed reactor.

### DETAILED DESCRIPTION

The present disclosure relates to methods of preparing a dry gel zeolite. In some embodiments, the method includes: combining zeolite precursor materials; stirring the zeolite precursor materials to form a zeolite hydrogel; heating the zeolite hydrogel to form a zeolite dry gel; loading the zeolite dry gel into a fixed bed reactor; heating the fixed bed reactor to a temperature from about 100° C. to about 200° C.; and while maintaining the fixed bed reactor at the temperature, flowing a steam into the fixed bed reactor to pass through the zeolite dry gel, forming a zeolite from the zeolite dry gel. The use of the disclosed fixed bed reactor allows steam formed from heating to contact the zeolite dry gel to convert it to a zeolite. Conventional methods of zeolite synthesis without using a fixed bed reactor may require longer crystallization time, lower product yield, lower zeolite crystallinity, require higher temperature, and require higher energy.

In this disclosure, the terms “a,” “an,” and “the” are used to include one or more than one unless the context clearly dictates otherwise. The term “or” is used to refer to a nonexclusive “or” unless otherwise indicated. The statement “at least one of A and B” has the same meaning as “A, B, or A and B.” In addition, it is to be understood that the phraseology or terminology employed in this disclosure, and not otherwise defined, is for the purpose of description only and not of limitation. Any use of section headings is intended to aid reading of the document and is not to be interpreted as limiting; information that is relevant to a section heading may occur within or outside of that particular section.

The term “about” as used herein can allow for a degree of variability in a value or range, for example, within 10% of a stated value or of a stated limit of a range.

Values expressed in a range format should be interpreted in a flexible manner to include not only the numerical values explicitly recited as the limits of the range, but also to include all the individual numerical values or sub-ranges encompassed within that range as if each numerical value and sub-range is explicitly recited. For example, a range of “about 0.1% to about 5%” or “about 0.1% to 5%” should be interpreted to include not just about 0.1% to about 5%, but also the individual values (for example, 1%, 2%, 3%, and 4%) and the sub-ranges (for example, 0.1% to 0.5%, 1.1% to 2.2%, 3.3% to 4.4%) within the indicated range. The statement “about X to Y” has the same meaning as “about X to about Y,” unless indicated otherwise. Likewise, the statement “about X, Y, or about Z” has the same meaning as “about X, about Y, or about Z,” unless indicated otherwise.

In the methods described in the present disclosure, the acts can be carried out in any order, except when a temporal or operational sequence is explicitly recited. Furthermore, specified acts can be carried out concurrently unless explicit claim language recites that they be carried out separately. For example, a claimed act of doing X and a claimed act of doing Y can be conducted simultaneously within a single operation, and the resulting process will fall within the literal scope of the claimed process.

In some embodiments, the method includes combining zeolite precursor materials.

In some embodiments, the method includes stirring the zeolite precursor materials to form a zeolite hydrogel.

In some embodiments, the zeolite precursor materials are stirred for about 1 min to about 24 h. In some embodiments, the zeolite precursor materials are stirred for about 5 min to about 12 h. In some embodiments, the zeolite precursor materials are stirred for about 15 min to about 6 h. In some embodiments, the zeolite precursor materials are stirred for about 30 min to about 4 h. In some embodiments, the zeolite precursor materials are stirred for about 1 h to about 2 h.

In some embodiments, the zeolite precursor materials are stirred for about 1 min. In some embodiments, the zeolite precursor materials are stirred for about 5 min. In some embodiments, the zeolite precursor materials are stirred for about 15 min. In some embodiments, the zeolite precursor materials are stirred for about 30 min. In some embodiments, the zeolite precursor materials are stirred for about 1 h. In some embodiments, the zeolite precursor materials are stirred for about 2 h. In some embodiments, the zeolite precursor materials are stirred for about 4 h. In some embodiments, the zeolite precursor materials are stirred for about 6 h. In some embodiments, the zeolite precursor materials are stirred for about 8 h. In some embodiments, the zeolite precursor materials are stirred for about 12 h. In some embodiments, the zeolite precursor materials are stirred for about 16 h. In some embodiments, the zeolite precursor materials are stirred for about 24 h.

In some embodiments, the zeolite precursor materials are stirred at a temperature of about 0° C. to about 100° C. In some embodiments, the zeolite precursor materials are stirred at a temperature of about 10° C. to about 80° C. In some embodiments, the zeolite precursor materials are stirred at a temperature of about 20° C. to about 60° C.

In some embodiments, the zeolite precursor materials are stirred at a temperature of about 0° C. In some embodiments, the zeolite precursor materials are stirred at a temperature of about 10° C. In some embodiments, the zeolite precursor materials are stirred at a temperature of about 20° C. In some embodiments, the zeolite precursor materials are stirred at a temperature of about 40° C. In some embodiments, the zeolite precursor materials are stirred at a temperature of about 60° C. In some embodiments, the zeolite precursor materials are stirred at a temperature of about 80° C. In some embodiments, the zeolite precursor materials are stirred at a temperature of about 100° C.

In some embodiments, the zeolite precursor materials are stirred at room temperature.

In some embodiments, the method includes heating the zeolite hydrogel to form a zeolite dry gel.

In some embodiments, the zeolite hydrogel is heated for about 1 h to about 48 h. In some embodiments, the zeolite hydrogel is heated for about 2 h to about 36 h. In some embodiments, the zeolite hydrogel is heated for about 4 h to about 30 h. In some embodiments, the zeolite hydrogel is heated for about 8 h to about 24 h. In some embodiments, the zeolite hydrogel is heated for about 12 h to about 20 h.

In some embodiments, the zeolite hydrogel is heated for about 1 h. In some embodiments, the zeolite hydrogel is heated for about 2 h. In some embodiments, the zeolite hydrogel is heated for about 4 h. In some embodiments, the zeolite hydrogel is heated for about 8 h. In some embodiments, the zeolite hydrogel is heated for about 12 h. In some embodiments, the zeolite hydrogel is heated for about 16 h. In some embodiments, the zeolite hydrogel is heated for about 18 h. In some embodiments, the zeolite hydrogel is heated for about 20 h. In some embodiments, the zeolite hydrogel is heated for about 24 h. In some embodiments, the zeolite hydrogel is heated for about 30 h. In some embodiments, the zeolite hydrogel is heated for about 36 h. In some embodiments, the zeolite hydrogel is heated for about 48 h.

In some embodiments, the method includes loading the zeolite dry gel into a fixed bed reactor.

In some embodiments, the method further includes, while heating the zeolite hydrogel, stirring the zeolite hydrogel.

In some embodiments, the method further includes drying the hydrogel in an oven. In some embodiments, the method further includes, prior to loading the zeolite dry gel into the fixed bed reactor, grounding the zeolite dry gel into a powder form.

In some embodiments, the loading of the zeolite dry gel into the fixed bed reactor further includes: inserting a support in the fixed bed reactor; and placing the zeolite dry gel over the support.

In some embodiments, the method further includes, while flowing the steam into the fixed bed reactor, holding a pressure from about 1 bar to about 20 bar in the fixed bed reactor.

In some embodiments, the method further includes flowing a carrier gas into the fixed bed reactor to pressurize the fixed bed reactor.

In some embodiments, flowing the steam into the fixed bed reactor includes: using a pump connected to a tank comprising water, flowing the water to the fixed bed reactor at a flow rate from about 100 mL/h to about 300 mL/h; and generating the steam from the water flowed at the flow rate.

The present disclosure further relates to methods of preparing a zeolite, the methods including: loading a zeolite dry gel into a fixed bed reactor including a tubular reactor body, a support within the tubular reactor body to support the zeolite dry gel, and a furnace to heat the tubular reactor body; using the furnace, heating the fixed bed reactor to a temperature from about 100° C. to about 200° C.; and, while maintaining the fixed bed reactor at the temperature, flowing a steam into the fixed bed reactor to pass through the zeolite dry gel, forming a zeolite from the zeolite dry gel.

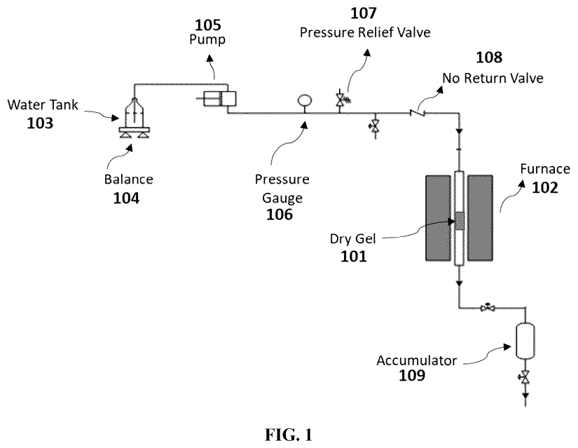

In some embodiments, the fixed bed reactor is as shown in FIG. 1. In this example, the dry gel zeolite 101 is loaded into a tubular reactor body within a furnace 102, where the reactor further includes a water tank 103 disposed on a balance 104; a pump 105 configured to flow the water from the tank 103 to the fixed bed reactor; a pressure gauge 106 to monitor a pressure inside the fixed bed reactor; a pressure relief valve 107 disposed between the pump 105 and the fixed bed reactor; a no return valve 108 disposed between the pressure relief valve 107 and the fixed bed reactor; and an accumulator 109 disposed downstream to the fixed bed reactor to collect water.

In some embodiments, the fixed bed reactor is a part of a reactor system including: a tank comprising water; and a pump configured to flow the water from the tank to the fixed bed reactor at a flow rate from about 100 mL/h to about 300 mL/h, where the steam is generated from the water.

In some embodiments, the reactor system further includes: a pressure gauge to monitor a pressure inside the fixed bed reactor; a pressure relief valve disposed between the pump and the fixed bed reactor; and a no return valve disposed between the pressure relief valve and the fixed bed reactor.

In some embodiments, the reactor system further includes an accumulator disposed downstream to the fixed bed reactor.

In some embodiments, the reactor system further includes a heating section disposed upstream to the tubular reactor body and configured to generate the steam from the water before entering the tubular reactor body.

In some embodiments, the fixed bed reactor is positioned vertically, and the steam passing through the zeolite dry gel from a top side to a bottom side.

The present disclosure further relates to methods of preparing a zeolite, the methods including: forming a zeolite hydrogel by mixing zeolite precursors in water, the zeolite precursors comprising an aluminum source, a silica source, and a template source; heating the zeolite hydrogel under stirring; drying the zeolite hydrogel in an oven, forming a zeolite dry gel; grounding the zeolite dry gel into a powder form; after grounding, loading the zeolite dry gel into a fixed bed reactor; heating the fixed bed reactor to a temperature from about 100° C. to about 200° C.; and while maintaining the fixed bed reactor at the temperature, flowing a steam into the fixed bed reactor to pass through the zeolite dry gel, forming a zeolite from the zeolite dry gel; washing the zeolite with water; and calcinating the zeolite at a temperature from about 550° C. to about 750° C.

In some embodiments, the fixed bed reactor is heated to a temperature from about 100° C. to about 200° C. In some embodiments, the fixed bed reactor is heated to a temperature from about 110° C. to about 190° C. In some embodiments, the fixed bed reactor is heated to a temperature from about 120° C. to about 180° C. In some embodiments, the fixed bed reactor is heated to a temperature from about 130° C. to about 170° C. In some embodiments, the fixed bed reactor is heated to a temperature from about 140° C. to about 160° C.

In some embodiments, the fixed bed reactor is heated to a temperature of about 100° C. In some embodiments, the fixed bed reactor is heated to a temperature of about 110° C. In some embodiments, the fixed bed reactor is heated to a temperature of about 120° C. In some embodiments, the fixed bed reactor is heated to a temperature of about 130° C. In some embodiments, the fixed bed reactor is heated to a temperature of about 140° C. In some embodiments, the fixed bed reactor is heated to a temperature of about 150° C. In some embodiments, the fixed bed reactor is heated to a temperature of about 160° C. In some embodiments, the fixed bed reactor is heated to a temperature of about 170° C. In some embodiments, the fixed bed reactor is heated to a temperature of about 180° C. In some embodiments, the fixed bed reactor is heated to a temperature of about 190° C. In some embodiments, the fixed bed reactor is heated to a temperature of about 200° C.

In some embodiments, the pressure in the fixed bed reactor is from about 1 bar to about 20 bar. In some embodiments, the pressure in the fixed bed reactor is from about 2 bar to about 16 bar. In some embodiments, the pressure in the fixed bed reactor is from about 3 bar to about 14 bar. In some embodiments, the pressure in the fixed bed reactor is from about 4 bar to about 12 bar. In some embodiments, the pressure in the fixed bed reactor is from about 5 bar to about 10 bar. In some embodiments, the pressure in the fixed bed reactor is from about 6 bar to about 8 bar.

In some embodiments, the pressure in the fixed bed reactor is from about 1 bar. In some embodiments, the pressure in the fixed bed reactor is from about 2 bar. In some embodiments, the pressure in the fixed bed reactor is from about 3 bar. In some embodiments, the pressure in the fixed bed reactor is from about 4 bar. In some embodiments, the pressure in the fixed bed reactor is from about 5 bar. In some embodiments, the pressure in the fixed bed reactor is from about 6 bar. In some embodiments, the pressure in the fixed bed reactor is from about 8 bar. In some embodiments, the pressure in the fixed bed reactor is from about 10 bar. In some embodiments, the pressure in the fixed bed reactor is from about 12 bar. In some embodiments, the pressure in the fixed bed reactor is from about 14 bar. In some embodiments, the pressure in the fixed bed reactor is from about 16 bar. In some embodiments, the pressure in the fixed bed reactor is from about 18 bar. In some embodiments, the pressure in the fixed bed reactor is from about 20 bar.

In some embodiments, the zeolite precursor materials include an aluminum source. In some embodiments, the zeolite precursor materials include a silica source. In some embodiments, the zeolite precursor materials include a template source.

In some embodiments, the zeolite precursor materials include an aluminum source and a silica source. In some embodiments, the zeolite precursor materials include an aluminum source and a template source. In some embodiments, the zeolite precursor materials include a silica source, and a template source.

In some embodiments, the zeolite precursor materials include an aluminum source, a silica source, and a template source.

In some embodiments, the aluminum source is selected from NaAlO₂, aluminum isopropoxide (AIP), Al₂(SO₄)₃, Al(NO₃)₃, AlCl₃, metal Al, aluminum powder, Al(OH)₃, and Al₂O₃. In some embodiments, the aluminum source is selected from Al₂(SO₄)₃ and Al(NO₃)₃. In some embodiments, the aluminum source is NaAlO₂. In some embodiments, the aluminum source is aluminum isopropoxide (AIP). In some embodiments, the aluminum source is Al₂(SO₄)₃. In some embodiments, the aluminum source is Al(NO₃)₃. In some embodiments, the aluminum source is AlCl₃. In some embodiments, the aluminum source is metal Al. In some embodiments, the aluminum source is aluminum powder. In some embodiments, the aluminum source is Al(OH)₃. In some embodiments, the aluminum source is Al₂O₃.

In some embodiments, the silicon source is selected from tetraethylorthosilicate (TEOS), colloidal silica, Na₂SiO₃, and fumed silica. In some embodiments, the silicon source is tetraethylorthosilicate (TEOS). In some embodiments, the silicon source is colloidal silica. In some embodiments, the silicon source is Na₂SiO₃. In some embodiments, the silicon source is fumed silica.

In some embodiments, the template source is selected from tetrapropylammonium hydroxide (TPAOH) and tetraethylammonium hydroxide (TEAOH). In some embodiments, the template source is tetrapropylammonium hydroxide (TPAOH). In some embodiments, the template source is tetraethylammonium hydroxide (TEAOH).

In some embodiments, the zeolite precursor materials include an aluminum source, a silica source, and a template source, where:
the aluminum source is selected from NaAlO₂, aluminum isopropoxide (AIP), Al₂(SO₄)₃, Al(NO₃)₃, AlCl₃, metal Al, aluminum powder, Al(OH)₃, and Al₂O₃;
the silica source is selected from tetraethylorthosilicate (TEOS), colloidal silica, Na₂SiO₃, and fumed silica; and
the template source is selected from tetrapropylammonium hydroxide (TPAOH) and tetraethylammonium hydroxide (TEAOH).

In some embodiments, the zeolite precursor materials include an aluminum source, a silica source, and a template source, where:
the aluminum source is selected from Al₂(SO₄)₃ and Al(NO₃)₃;
the silica source is fumed silica; and
the template source is selected from tetrapropylammonium hydroxide (TPAOH) and tetraethylammonium hydroxide (TEAOH).

In some embodiments, the aluminum source is Al₂(SO₄)₃, the silica source is fumed silica, and the template source is tetrapropylammonium hydroxide.

In some embodiments, the aluminum source is Al₂(SO₄)₃, the silica source is fumed silica, and tetraethylammonium hydroxide (TEAOH).

In some embodiments, the aluminum source is Al(NO₃)₃, the silica source is fumed silica, and the template source is tetrapropylammonium hydroxide.

In some embodiments, the aluminum source is Al(NO₃)₃, the silica source is fumed silica, and tetraethylammonium hydroxide (TEAOH).

In some embodiments, the dry gel zeolite is ZSM-5 or zeolite beta. In some embodiments, the dry gel zeolite is ZSM-5. In some embodiments, the dry gel zeolite is zeolite beta.

In some embodiments, calcinating the zeolite includes heating the zeolite to a temperature of about 450° C. to about 650° C. In some embodiments, calcinating the zeolite includes heating the zeolite to a temperature of about 475° C. to about 625° C. In some embodiments, calcinating the zeolite includes heating the zeolite to a temperature of about 500° C. to about 600° C. In some embodiments, calcinating the zeolite includes heating the zeolite to a temperature of about 525° C. to about 575° C.

In some embodiments, calcinating the zeolite includes heating the zeolite to a temperature of about 450° C. In some embodiments, calcinating the zeolite includes heating the zeolite to a temperature of about 475° C. In some embodiments, calcinating the zeolite includes heating the zeolite to a temperature of about 500° C. In some embodiments, calcinating the zeolite includes heating the zeolite to a temperature of about 525° C. In some embodiments, calcinating the zeolite includes heating the zeolite to a temperature of about 550° C. In some embodiments, calcinating the zeolite includes heating the zeolite to a temperature of about 575° C. In some embodiments, calcinating the zeolite includes heating the zeolite to a temperature of about 600° C. In some embodiments, calcinating the zeolite includes heating the zeolite to a temperature of about 625° C. In some embodiments, calcinating the zeolite includes heating the zeolite to a temperature of about 650° C.

In some embodiments, calcinating the zeolite includes heating the zeolite for about 1 h to about 8 h. In some embodiments, calcinating the zeolite includes heating the zeolite for about 2 h to about 6 h. In some embodiments, calcinating the zeolite includes heating the zeolite for about 3 h to about 5 h.

In some embodiments, calcinating the zeolite includes heating the zeolite for about 1 h. In some embodiments, calcinating the zeolite includes heating the zeolite for about 2 h. In some embodiments, calcinating the zeolite includes heating the zeolite for about 3 h. In some embodiments, calcinating the zeolite includes heating the zeolite for about 4 h. In some embodiments, calcinating the zeolite includes heating the zeolite for about 5 h. In some embodiments, calcinating the zeolite includes heating the zeolite for about 6 h. In some embodiments, calcinating the zeolite includes heating the zeolite for about 7 h. In some embodiments, calcinating the zeolite includes heating the zeolite for about 8 h.

In some embodiments, calcinating the zeolite includes heating the zeolite to a temperature of about 450° C. to about 650° C. for about 1 h to about 8 h. In some embodiments, calcinating the zeolite includes heating the zeolite to a temperature of about 500° C. to about 600° C. for about 2 h to about 6 h. In some embodiments, calcinating the zeolite includes heating the zeolite to a temperature of about 525° C. to about 570° C. for about 3 h to about 5 h.

In some embodiments, calcinating the zeolite includes heating the zeolite to a temperature of about 550° C. for about 4 h. In some embodiments, calcinating the zeolite includes heating the zeolite to a temperature of about 650° C. for about 4 h.

In some embodiments, heating the dry gel zeolite to form a zeolite using the disclosed fixed bed reactor requires a lower temperature than a method of heating the dry gel zeolite to form a zeolite that does not use the disclosed fixed bed reactor.

In some embodiments, heating the dry gel zeolite to form a zeolite using the disclosed fixed bed reactor requires a shorter heating time than a method of heating the dry gel zeolite to form a zeolite that does not use the disclosed fixed bed reactor.

In some embodiments, heating the dry gel zeolite to form a zeolite using the disclosed fixed bed reactor requires a lower temperature and shorter heating time than a method of heating the dry gel zeolite to form a zeolite that does not use the disclosed fixed bed reactor.

In some embodiments, the zeolite has a relative crystallinity greater than the relative crystallinity of a zeolite prepared without using the disclosed fixed bed reactor.

In some embodiments, the zeolite has a relative crystallinity of about 70% or greater. In some embodiments, the zeolite has a relative crystallinity of about 75% or greater. In some embodiments, the zeolite has a relative crystallinity of about 80% or greater. In some embodiments, the zeolite has a relative crystallinity of about 85% or greater. In some embodiments, the zeolite has a relative crystallinity of about 90% or greater. In some embodiments, the zeolite has a relative crystallinity of about 95% or greater. In some embodiments, the zeolite has a relative crystallinity of about 98% or greater. In some embodiments, the zeolite has a relative crystallinity of about 99% or greater. In some embodiments, the zeolite has a relative crystallinity of about 99.9% or greater.

In some embodiments, the zeolite has a relative crystallinity of about 75% to about 99.9%. In some embodiments, the zeolite has a relative crystallinity of about 80% to about 99%. In some embodiments, the zeolite has a relative crystallinity of about 85% to about 98%. In some embodiments, the zeolite has a relative crystallinity of about 90% to about 95%.

In some embodiments, the zeolite has a relative crystallinity of about 75%. In some embodiments, the zeolite has a relative crystallinity of about 80%. In some embodiments, the zeolite has a relative crystallinity of about 85%. In some embodiments, the zeolite has a relative crystallinity of about 90%. In some embodiments, the zeolite has a relative crystallinity of about 95%. In some embodiments, the zeolite has a relative crystallinity of about 98%. In some embodiments, the zeolite has a relative crystallinity of about 99%. In some embodiments, the zeolite has a relative crystallinity of about 99.9%. In some embodiments, the zeolite has a relative crystallinity of about 100%.

In some embodiments, the zeolite has an average particle size of about 1 nm to about 150 nm. In some embodiments, the zeolite has an average particle size of about 5 nm to about 125 nm. In some embodiments, the zeolite has an average particle size of about 10 nm to about 100 nm. In some embodiments, the zeolite has an average particle size of about 25 nm to about 75 nm. In some embodiments, the zeolite has an average particle size of about 40 nm to about 60 nm.

In some embodiments, the zeolite has an average particle size of about 1 nm. In some embodiments, the zeolite has an average particle size of about 5 nm. In some embodiments, the zeolite has an average particle size of about 10 nm. In some embodiments, the zeolite has an average particle size of about 20 nm. In some embodiments, the zeolite has an average particle size of about 25 nm. In some embodiments, the zeolite has an average particle size of about 30 nm. In some embodiments, the zeolite has an average particle size of about 40 nm. In some embodiments, the zeolite has an average particle size of about 50 nm. In some embodiments, the zeolite has an average particle size of about 60 nm. In some embodiments, the zeolite has an average particle size of about 70 nm. In some embodiments, the zeolite has an average particle size of about 75 nm. In some embodiments, the zeolite has an average particle size of about 80 nm. In some embodiments, the zeolite has an average particle size of about 90 nm. In some embodiments, the zeolite has an average particle size of about 100 nm. In some embodiments, the zeolite has an average particle size of about 110 nm. In some embodiments, the zeolite has an average particle size of about 125 nm. In some embodiments, the zeolite has an average particle size of about 150 nm.

In some embodiments, the zeolite has an average surface area of about 350 m²/g to about 800 m²/g. In some embodiments, the zeolite has an average surface area of about 450 m²/g to about 750 m²/g. In some embodiments, the zeolite has an average surface area of about 500 m²/g to about 700 m²/g. In some embodiments, the zeolite has an average surface area of about 550 m²/g to about 650 m²/g.

In some embodiments, the zeolite has an average surface area of about 350 m²/g. In some embodiments, the zeolite has an average surface area of about 400 m²/g. In some embodiments, the zeolite has an average surface area of about 450 m²/g. In some embodiments, the zeolite has an average surface area of about 500 m²/g. In some embodiments, the zeolite has an average surface area of about 550 m²/g. In some embodiments, the zeolite has an average surface area of about 600 m²/g. In some embodiments, the zeolite has an average surface area of about 650 m²/g. In some embodiments, the zeolite has an average surface area of about 700 m²/g. In some embodiments, the zeolite has an average surface area of about 750 m²/g. In some embodiments, the zeolite has an average surface area of about 800 m²/g.

In some embodiments, the zeolite has an average pore volume of about 0.1 mL/g to about 5.0 mL/g. In some embodiments, the zeolite has an average pore volume of about 0.25 mL/g to about 2.5 mL/g. In some embodiments, the zeolite has an average pore volume of about 0.3 mL/g to about 1.2 mL/g. In some embodiments, the zeolite has an average pore volume of about 0.4 mL/g to about 1.1 ml/g. In some embodiments, the zeolite has an average pore volume of about 0.5 mL/g to about 1.0 mL/g. In some embodiments, the zeolite has an average pore volume of about 0.6 mL/g to about 0.8 mL/g.

In some embodiments, the zeolite has an average pore volume of about 0.1 ml/g. In some embodiments, the zeolite has an average pore volume of about 0.25 mL/g. In some embodiments, the zeolite has an average pore volume of about 0.3 mL/g. In some embodiments, the zeolite has an average pore volume of about 0.4 mL/g. In some embodiments, the zeolite has an average pore volume of about 0.5 mL/g. In some embodiments, the zeolite has an average pore volume of about 0.6 mL/g. In some embodiments, the zeolite has an average pore volume of about 0.7 mL/g. In some embodiments, the zeolite has an average pore volume of about 0.8 mL/g. In some embodiments, the zeolite has an average pore volume of about 0.9 mL/g. In some embodiments, the zeolite has an average pore volume of about 1.0 mL/g. In some embodiments, the zeolite has an average pore volume of about 1.1 mL/g. In some embodiments, the zeolite has an average pore volume of about 1.2 mL/g. In some embodiments, the zeolite has an average pore volume of about 2.5 mL/g. In some embodiments, the zeolite has an average pore volume of about 5.0 mL/g.

In some embodiments, the zeolites of the present disclosure can be used for petroleum processing. In some embodiments, the zeolites of the present disclosure can be used for catalytic cracking, catalytic reforming, and hydrocracking. In some embodiments, the zeolites of the present disclosure can be used for catalytic cracking. In some embodiments, the zeolites of the present disclosure can be used for catalytic reforming. In some embodiments, the zeolites of the present disclosure can be used for hydrocracking.

### EXAMPLES

### Example 1. Comparison of the Fixed Bed Reactor with Conventional Autoclaves

To compare the effect of a dry gel fixed bed on zeolite properties, two ZSM-5 and two zeolite beta samples (Ref-ZSM-5-A, Ref-ZSM-5-B, Ref-Beta-A, and Ref-Beta-B) were synthesized with conventional autoclaves and compared to two ZSM-5 and two zeolite beta samples prepared using the disclosed fixed bed reactor (Inv-ZSM-5-A, Inv-ZSM-5-B, Inv-Beta-A, and Inv-Beta-B). The results are summarized below in Table 1.

When the conventional autoclave was used, the synthesis repeatability was poor compared to the syntheses performed using the disclosed fixed bed reactor. With the fixed bed reactor, higher zeolite crystallinity was observed even when using shorter crystallization times and/or lower temperatures. The zeolite pore volume and surface area were increased when using the fixed bed reactor compared to the conventional autoclave.

### Experiment 1: Synthesis of Reference ZSM-5 with Conventional Holder (Ref-ZSM-5-A (NanoZ-34))

1. Al(NO₃)₃·9H₂O (1.20 g) was added to TPAOH (24.36 g, aq. 40%) and H₂O (14.18 g) and stirred at room temperature for 2 h.
2. TEOS (16.67 g) and 0.02 g NaOH (0.02 g) were added to the solution and stirred for 2 h.
3. The solution was stirred and heated to 80° C. until the stir bar could no longer move.
4. The resulting zeolite hydrogel was dried in an oven at 80° C. overnight.
5. The dry gel zeolite was ground to a powder and put in the TEFL holder, which was loaded in an autoclave with water (10 mL). The autoclave was heated at 170° C. for 72 h.
6. The zeolite was separated from the mother liquor, washed with deionized water, and dried at 110° C. overnight.
7. The zeolite was calcinated at 550° C. in air for 4 h.

### Experiment 2: Synthesis of Reference ZSM-5 with Conventional Holder (Ref-ZSM-5-B (NanoZ-28D))

1. Al(NO₃)₃·9H₂O (1.50 g) was added to TPAOH (36.6 g) and H₂O (16.38 g) and stirred at room temperature for 30 min.
2. Fumed silica (12.02 g) was added to the solution and stirred for 2 h.
3. The solution was stirred and heated to 80° C. until the stir bar could no longer move.
4. The resulting zeolite hydrogel was dried in an oven at 110° C. overnight.
5. The dry gel zeolite was ground to a powder and put in the TEFL holder, which was loaded in an autoclave with water (10 mL). The autoclave was heated at 170° C. for 72 h.
6. The synthesized samples were separated from the mother liquor, washed with deionized water, and dried at 110° C. overnight.
7. The zeolite was dried at 120° C. for 6 h.
8. The zeolite was calcinated at 550° C. for 4 h (ramp rate 2° C./min).

### Experiment 3: Synthesis of Reference Zeolite Beta with Conventional Holder (Ref-Beta-A (DG-NB-58))

1. Al₂(SO₄)₃ (3.15 g) was added to TEAOH (31.56 g, 35% aq. solution) and stirred at room temperature until Al₂(SO₄)₃ dissolved.
2. Fumed silica (7.5 g) was added to the solution and stirred for 4 h at room temperature.
3. The solution was stirred and heated to 80° C. until the stir bar could no longer move.
4. The resulting zeolite hydrogel was dried in an oven at 80° C. overnight.
5. The dry gel zeolite was ground to a powder and put in the TEFL holder, which was loaded in an autoclave with water (10 mL). The autoclave was heated at 140° C. for 72 h.
6. The zeolite was washed three times with deionized water.
7. The zeolite was dried at 110° C. overnight.
8. The zeolite was calcinated at 550° C. for 4 h (ramp rate 2° C./min).

### Experiment 4: Synthesis of Reference Zeolite Beta with Conventional Holder (Ref-Beta-B (DG-NB-55))

1. Al₂(SO₄)₃ (3.15 g) was added to water (10 g) and stirred at 80° C. until it dissolved.
2. NaOH (0.6 g) was dissolved in water (12.65 g).
3. TEAOH (25.24 g, 35% aq. solution) and colloidal silica (22.50 g, 40%) was added to the NaOH solution and stirred at room temperature for 30 min.
4. The Al₂(SO₄)₃ solution was added to the TEAOH, NaOH, and colloidal silica solution and the combined mixture was stirred at room temperature for 2 h.
5. The solution was stirred and heated to 80° C. until the stir bar could no longer move.
6. The resulting zeolite hydrogel was dried in an oven at 80° C. overnight.
7. The dry gel zeolite was ground to a powder and put in the TEFL holder, which was loaded in an autoclave with water (10 mL). The autoclave was heated at 175° C. for 24 h.
8. The zeolite was washed two times with deionized water.
9. The zeolite was dried at 110° C. overnight.
10. The zeolite was calcinated at 550° C. for 4 h (ramp rate 2° C./min).

### Experiment 5: Synthesis of ZSM-5 with Fixed Bed Reactor (Inv-ZSM-5-A)

1. Al(NO₃)₃·9H₂O (1.20 g) was added to TPAOH (24.36 g, aq. 40%) and H₂O (14.18 g) and stirred at room temperature for 2 h.
2. TEOS (16.67 g) and 0.02 g NaOH (0.02 g) were added to the solution and stirred for 2 h.
3. The solution was stirred and heated to 80° C. until the stir bar could no longer move.
4. The resulting zeolite hydrogel was dried in an oven at 80° C. overnight.
5. The dry gel zeolite was ground to a powder and loaded into the fixed bed reactor. About 2 mL of 100 mesh inert SiC was added to the bottom of the reactor, and then 3 mL of the solid sample.
6. The reactor was heated to 140° C. Water was pumped into the reactor with a flowrate of 200 mL/h. The reaction temperature was maintained at 140° C. for 2 d, while the pressure was maintained at 5 bar.
7. The zeolite was washed with deionized water twice and dried at 110° C. overnight.
8. The zeolite was calcinated at 650° C. in air for 4 h.

### Experiment 6: Synthesis of ZSM-5 with Fixed Bed Reactor (Inv-ZSM-5-B)

1. Al(NO₃)₃·9H₂O (1.50 g) was added to TPAOH (36.6 g) and H₂O (16.38 g) and stirred at room temperature for 30 min.
2. Fumed silica (12.02 g) was added to the solution and stirred for 2 h.
3. The solution was stirred and heated to 80° C. until the stir bar could no longer move.
4. The resulting zeolite hydrogel was dried in an oven at 110° C. overnight.
5. The dry gel zeolite was ground to a powder and loaded into the fixed bed reactor. About 2 mL of 100 mesh inert SiC was added to the bottom of the reactor, and then 3 mL of the solid sample.
6. The reactor was heated to 160° C. Water was pumped into the reactor with a flowrate of 200 mL/h. The reaction temperature was maintained at 160° C. for 2 d, while the pressure was maintained at atmospheric pressure.
7. The solid sample was washed with deionizied water twice.
8. The zeolite was dried at 110° C. overnight.
9. The zeolite was calcinated at 550° C. for 4 h.

### Experiment 7: Synthesis of Zeolite Beta with Fixed Bed Reactor (Inv-Beta-A)

1. Al₂(SO₄)₃ (3.15 g) was added to TEAOH (31.56 g, 35% aq. solution) and stirred at room temperature until Al₂(SO₄)₃ dissolved.
2. Fumed silica (7.5 g) was added to the solution and stirred for 4 h at room temperature.
3. The solution was stirred and heated to 80° C. until the stir bar could no longer move.
4. The resulting zeolite hydrogel was dried in an oven at 80° C. overnight.
5. The dry gel zeolite was ground to a powder and loaded into the fixed bed reactor. About 2 mL of 100 mesh inert SiC was added to the bottom of the reactor, and then 3 mL of the solid sample.
6. The reactor was heated to 140° C. Water was pumped into the reactor with a flowrate of 200 mL/h. The reaction temperature was maintained at 140° C. for 2 d, while the pressure was maintained at atmospheric pressure.
7. The zeolite was dried at 110° C. overnight.
8. The zeolite was calcinated at 550° C. for 4 h (ramp rate 2° C./min).

### Experiment 8: Synthesis of Zeolite Beta with Fixed Bed Reactor (Inv-Beta-B)

1. Al₂(SO₄)₃ (3.15 g) was added to water (10 g) and stirred at 80° C. until it dissolved.
2. NaOH (0.6 g) was dissolved in water (12.65 g).
3. TEAOH (25.24 g, 35% aq. solution) and colloidal silica (22.50 g, 40%) was added to the NaOH solution and stirred at room temperature for 30 min.
4. The Al₂(SO₄)₃ solution was added to the TEAOH, NaOH, and colloidal silica solution and the combined mixture was stirred at room temperature for 2 h.
5. The solution was stirred and heated to 80° C. until the stir bar could no longer move.
6. The resulting zeolite hydrogel was dried in an oven at 80° C. overnight.
7. The dry gel zeolite was ground to a powder and loaded into the fixed bed reactor. About 2 mL of 100 mesh inert SiC was added to the bottom of the reactor, and then 3 mL of the solid sample.
8. The reactor was heated to 140° C. Water was pumped into the reactor with a flowrate of 200 mL/h. The reaction temperature was maintained at 140° C. for 1 d, while the pressure was maintained at 10 bar.
9. The zeolite was dried at 110° C. overnight.
10. The zeolite was calcinated at 550° C. for 4 h (ramp rate 2° C./min).

TABLE 1
Main properties of four zeolites prepared using a conventional
holder and those prepared using a fixed bed reactor

| Ref- | Ref- | Ref- | Ref- | Inv- | Inv- | Inv- | Inv- |
|---|---|---|---|---|---|---|---|
| ZSM-5-A | ZSM-5-B | Beta-A | Beta-B | ZSM-5-A | ZSM-5-B | Beta-A | Beta-B |
| Experiment No. | | | | | | | |
| 1 | 2 | 3 | 4 | 5 | 6 | 7 | 8 |

Synthesis Conditions

| | | | | | | | | |
|---|---|---|---|---|---|---|---|---|
| Crystallization | 170 | 170 | 140 | 175 | 140 | 160 | 140 | 140 |
| Temperature (° C.) | | | | | | | | |
| Crystallization Time (d) | 3 | 3 | 3 | 1 | 2 | 2 | 2 | 1 |
| Pressure (bar) | Auto | Auto | Auto | Auto | AM | 5 | AM | 10 |

Zeolite Properties

| | | | | | | | | |
|---|---|---|---|---|---|---|---|---|
| Yield (Wt %) | 90% | 91% | 89% | 88% | 90% | 91% | 89% | 88% |
| SiO₂/Al₂O₃ Ratio | 44 | 88 | 28 | 35 | 44 | 88 | 28 | 35 |
| Particle Size (nm)^{a} | 80 | 80 | 50 | 50 | 80 | 80 | 50 | 50 |
| Crystallinity (%) | 70 | 74 | 88 | 74 | 81 | 90 | 93 | 85 |
| Repeatability | Poor | Poor | Poor | Poor | Good | Good | Good | Good |
| Surface Area (m²/g)^{b} | 419 | 392 | 551 | 565 | 490 | 410 | 580 | 590 |
| Pore Volume (mL/g) | 0.90 | 0.69 | 1.04 | 0.96 | 1.00 | 0.71 | 1.10 | 1.20 |
| Average Pore Size (nm) | 8.6 | 7.0 | 7.6 | 6.8 | 8.2 | 6.9 | 7.6 | 8.1 |

^{a}As measured by SEM
^{b}Brunauer-Emmett-Teller surface area

### Other Embodiments

It is to be understood that while the invention has been described in conjunction with the detailed description thereof, the foregoing description is intended to illustrate and not limit the scope of the invention, which is defined by the scope of the appended claims. Other aspects, advantages, and modifications are within the scope of the following claims.

### Embodiments

Embodiment 1. A method of preparing a zeolite, the method comprising:
combining zeolite precursor materials;
stirring the zeolite precursor materials to form a zeolite hydrogel;
heating the zeolite hydrogel to form a zeolite dry gel;
loading the zeolite dry gel into a fixed bed reactor;
heating the fixed bed reactor to a temperature from about 100° C. to about 200° C.; and
while maintaining the fixed bed reactor at the temperature, flowing a steam into the fixed bed reactor to pass through the zeolite dry gel, forming a zeolite from the zeolite dry gel.

Embodiment 2. The method of embodiment 1, further comprising, while heating the zeolite hydrogel, stirring the zeolite hydrogel.

Embodiment 3. The method of embodiment 1 or 2, further comprising drying the hydrogel in an oven.

Embodiment 4. The method of any one of embodiments 1-3, further comprising, prior to loading the zeolite dry gel into the fixed bed reactor, grounding the zeolite dry gel into a powder form.

Embodiment 5. The method of any one of embodiments 1-4, wherein the loading of the zeolite dry gel into the fixed bed reactor further comprises:
inserting a support in the fixed bed reactor; and
placing the zeolite dry gel over the support.

Embodiment 6. The method of any one of embodiments 1-5, further comprising, while flowing the steam into the fixed bed reactor, holding a pressure from about 1 bar to about 20 bar in the fixed bed reactor.

Embodiment 7. The method of any one of embodiments 1-6, wherein the pressure is from about 5 bar to about 10 bar.

Embodiment 8. The method of any one of embodiments 1-7, further comprising flowing a carrier gas into the fixed bed reactor to pressurize the fixed bed reactor.

Embodiment 9. The method of any one of embodiments 1-8, wherein flowing the steam into the fixed bed reactor comprises:
using a pump connected to a tank comprising water, flowing the water to the fixed bed reactor at a flow rate from about 100 mL/h to about 300 mL/h; and
generating the steam from the water flowed at the flow rate.

Embodiment 10. The method of any one of embodiments 1-9, wherein the fixed bed reactor is heated to a temperature from about 140° C. to about 160° C.

Embodiment 11. A method of preparing a zeolite, the method comprising:
loading a zeolite dry gel into a fixed bed reactor comprising
   a tubular reactor body,
   a support within the tubular reactor body to support the zeolite dry gel, and
   a furnace to heat the tubular reactor body;
using the furnace, heating the fixed bed reactor to a temperature from about 100° C. to about 200° C.; and
while maintaining the fixed bed reactor at the temperature, flowing a steam into the fixed bed reactor to pass through the zeolite dry gel, forming a zeolite from the zeolite dry gel.

Embodiment 12. The method of embodiment 11, wherein the fixed bed reactor is a part of a reactor system comprising:
a tank comprising water; and
a pump configured to flow the water from the tank to the fixed bed reactor at a flow rate from about 100 mL/h to about 300 mL/h, wherein the steam is generated from the water.

Embodiment 13. The method of embodiment 12, wherein the reactor system further comprises:
a pressure gauge to monitor a pressure inside the fixed bed reactor;
a pressure relief valve disposed between the pump and the fixed bed reactor; and
a no return valve disposed between the pressure relief valve and the fixed bed reactor.

Embodiment 14. The method of embodiment 12 or 13, wherein the reactor system further comprises an accumulator disposed downstream to the fixed bed reactor.

Embodiment 15. The method of any one of embodiments 12-14, wherein the reactor system further comprises a heating section disposed upstream to the tubular reactor body and configured to generate the steam from the water before entering the tubular reactor body.

Embodiment 16. The method of any one of embodiments 12-15, wherein the fixed bed reactor is positioned vertically, and the steam passing through the zeolite dry gel from a top side to a bottom side.

Embodiment 17. A method of preparing a zeolite, the method comprising:
forming a zeolite hydrogel by mixing zeolite precursors in water, the zeolite precursors comprising an aluminum source, a silica source, and a template source;
heating the zeolite hydrogel under stirring;
drying the zeolite hydrogel in an oven, forming a zeolite dry gel;
grounding the zeolite dry gel into a powder form;
after grounding, loading the zeolite dry gel into a fixed bed reactor;
heating the fixed bed reactor to a temperature from about 100° C. to about 200° C.; and
while maintaining the fixed bed reactor at the temperature, flowing a steam into the fixed bed reactor to pass through the zeolite dry gel, forming a zeolite from the zeolite dry gel;
washing the zeolite with water; and
calcinating the zeolite at a temperature from about 550° C. to about 750° C.

Embodiment 18. The method of embodiment 17, wherein the aluminum source comprises NaAlO₂, aluminum isopropoxide (AIP), Al₂(SO₄)₃, Al(NO₃)₃, AlCl₃, metal Al, aluminum powder, Al(OH)₃, or Al₂O₃.

Embodiment 19. The method of embodiment 17 or 18, wherein the silicon source comprises tetraethylorthosilicate (TEOS), colloidal silica, Na₂SiO₃, or fumed silica.

Embodiment 20. The method of any one of embodiments 17-19, wherein the template source comprises tetrapropylammonium hydroxide (TPAOH) or tetraethylammonium hydroxide (TEAOH).

What is claimed is:

1. A method of preparing a zeolite, the method comprising:
combining zeolite precursor materials;
stirring the zeolite precursor materials to form a zeolite hydrogel;
heating the zeolite hydrogel to form a zeolite dry gel;
loading the zeolite dry gel into a fixed bed reactor;
heating the fixed bed reactor to a temperature from about 100° C. to about 200° C.; and
while maintaining the fixed bed reactor at the temperature, flowing a steam into the fixed bed reactor to pass through the zeolite dry gel, forming a zeolite from the zeolite dry gel.

2. The method of claim 1, further comprising, while heating the zeolite hydrogel, stirring the zeolite hydrogel.

3. The method of claim 1, further comprising drying the hydrogel in an oven.

4. The method of claim 1, further comprising, prior to loading the zeolite dry gel into the fixed bed reactor, grounding the zeolite dry gel into a powder form.

5. The method of claim 1, wherein the loading of the zeolite dry gel into the fixed bed reactor further comprises:
inserting a support in the fixed bed reactor; and
placing the zeolite dry gel over the support.

6. The method of claim 1, further comprising, while flowing the steam into the fixed bed reactor, holding a pressure from about 1 bar to about 20 bar in the fixed bed reactor.

7. The method of claim 2, wherein the pressure is from about 5 bar to about 10 bar.

8. The method of claim 1, further comprising flowing a carrier gas into the fixed bed reactor to pressurize the fixed bed reactor.

9. The method of claim 1, wherein flowing the steam into the fixed bed reactor comprises:
using a pump connected to a tank comprising water, flowing the water to the fixed bed reactor at a flow rate from about 100 ml/h to about 300 mL/h; and
generating the steam from the water flowed at the flow rate.

10. The method of claim 1, wherein the fixed bed reactor is heated to a temperature from about 140° C. to about 160° C.

11. A method of preparing a zeolite, the method comprising:
loading a zeolite dry gel into a fixed bed reactor comprising:
a tubular reactor body,
a support within the tubular reactor body to support the zeolite dry gel, and
a furnace to heat the tubular reactor body;
using the furnace, heating the fixed bed reactor to a temperature from about 100° C. to about 200° C.; and
while maintaining the fixed bed reactor at the temperature, flowing a steam into the fixed bed reactor to pass through the zeolite dry gel, forming a zeolite from the zeolite dry gel.

12. The method of claim 11, wherein the fixed bed reactor is a part of a reactor system comprising:
a tank comprising water; and
a pump configured to flow the water from the tank to the fixed bed reactor at a flow rate from about 100 mL/h to about 300 mL/h, wherein the steam is generated from the water.

13. The method of claim 12, wherein the reactor system further comprises:
a pressure gauge to monitor a pressure inside the fixed bed reactor;
a pressure relief valve disposed between the pump and the fixed bed reactor; and
a no return valve disposed between the pressure relief valve and the fixed bed reactor.

14. The method of claim 12, wherein the reactor system further comprises an accumulator disposed downstream to the fixed bed reactor.

15. The method of claim 12, wherein the reactor system further comprises a heating section disposed upstream to the tubular reactor body and configured to generate the steam from the water before entering the tubular reactor body.

16. The method of claim 12, wherein the fixed bed reactor is positioned vertically, and the steam passes through the zeolite dry gel from a top side to a bottom side.

17. A method of preparing a zeolite, the method comprising:
forming a zeolite hydrogel by mixing zeolite precursors in water, the zeolite precursors comprising an aluminum source, a silica source, and a template source;
heating the zeolite hydrogel under stirring;
drying the zeolite hydrogel in an oven, forming a zeolite dry gel;
grounding the zeolite dry gel into a power form;
after grounding, loading the zeolite dry gel into a fixed bed reactor;
heating the fixed bed reactor to a temperature from about 100° C. to about 200° C.; and
while maintaining the fixed bed reactor at the temperature, flowing a steam into the fixed bed reactor to pass through the zeolite dry gel, forming a zeolite from the zeolite dry gel;
washing the zeolite with water; and
calcinating the zeolite at a temperature from about 550° C. to about 750° C.

18. The method of claim 17, wherein the aluminum source comprises NaAlO₂, aluminum isopropoxide (AIP), Al₂(SO₄)₃, Al(NO₃)₃, AlCl₃, metal Al, aluminum powder, Al(OH)₃, or Al₂O₃.

19. The method of claim 17, wherein the silicon source comprises tetraethylorthosilicate (TEOS), colloidal silica, Na₂SiO₃, or fumed silica.

20. The method of claim 17, wherein the template source comprises tetrapropylammonium hydroxide (TPAOH) or tetraethylammonium hydroxide (TEAOH).
